(19) United States
(12) Patent Application Publication
(10) Pub. No.: US 2018/0224786 A1
(43) Pub. Date: Aug. 9, 2018

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Sunao Takenaka, Odawara Kanagawa (JP)

(21) Appl. No.: 15/467,072

(22) Filed: Mar. 23, 2017

(30) Foreign Application Priority Data
Feb. 6, 2017 (JP) 2017-019904

(51) Int. Cl. G03G 15/00

(52) U.S. Cl. CPC G03G 15/5062

(57) ABSTRACT

A sensor emits light to an image carrier and detects the amount of developer in a visible image which is formed in the image carrier by receiving light that is reflected from the image carrier. A light amount control unit determines the amount of light which is emitted by the sensor when the amount of developer is detected. An image formation control unit controls the amount of developer of a visible image which is formed in the image carrier in accordance with the amount of developer that is detected by the sensor. The light amount control unit determines the amount of light in accordance with a statistical value of the amount of received light of the reflected light in a plurality of regions in which the visible image is not formed.

### CROSS-REFERENCE TO RELATED APPLICATION

This application is based upon and claims the benefit of priority from Japanese Patent Application No. 2017-019904, filed Feb. 6, 2017, the entire contents of which are incorporated herein by reference.

### FIELD

Embodiments described herein relate generally to an image forming apparatus.

### BACKGROUND

An image forming apparatus forms a visible image in an image carrier such as an intermediate transfer belt by using developer, and transfers the visible image onto a sheet. If the amount of developer which is used for the visible image of the image carrier is not appropriate, quality of the image which is formed on the sheet may be adversely affected. Accordingly, technology is proposed which appropriately controls density of an image by detecting the amount of developer on the basis of the amount of received light of the light which is reflected from the visible image formed on the image carrier.

However, ripple due to noise may occur in the amount of received light (output of sensor) due to various factors. There are concerns that detection accuracy of the amount of developer decreases due to the ripple.

### DESCRIPTION OF THE DRAWINGS

FIG. 1 is an external view illustrating an overall configuration example of an image forming apparatus according to an embodiment.

FIG. 2 is a block diagram illustrating a functional configuration relating to visible image formation processing of the image forming apparatus according to the embodiment.

FIG. 3 is a diagram illustrating an example of an internal configuration of the image forming apparatus.

FIG. 4 is a diagram illustrating a specific example of a configuration of an adhesion amount sensor.

FIG. 5 is a diagram illustrating a specific example of an output of the adhesion amount sensor in a light amount adjustment mode.

FIG. 6 is a diagram illustrating reference voltage values which are obtained in a case where density adjustment processing is performed by control of the related art.

FIG. 7 is a diagram illustrating image voltage values which are obtained in a case where the density adjustment processing is performed by the control of the related art.

FIG. 8 is a diagram illustrating the reference voltage values in a case where the density adjustment processing is performed by control of the image forming apparatus according to the embodiment.

FIG. 9 is a diagram illustrating the image voltage values in a case where the density adjustment processing is performed by control of the image forming apparatus according to the embodiment.

FIG. 10 is a diagram illustrating a specific example of a toner adhesion amount pattern which is used for the density adjustment processing of the related art.

FIG. 11 is a diagram illustrating a specific example of the toner adhesion amount pattern which is used for the density adjustment processing of the image forming apparatus according to the embodiment.

FIG. 12 is a diagram illustrating a specific example of voltage values which are obtained in a case where the density adjustment processing is performed by using the toner adhesion amount pattern having a white portion.

FIG. 13 is a diagram illustrating the image voltage values in a case where the density adjustment processing is performed by the control of the image forming apparatus according to the embodiment.

FIG. 14 is a diagram illustrating a modified example of the adhesion amount sensor.

### DETAILED DESCRIPTION

An object of the invention is to provide an image forming apparatus which can increase detection accuracy of developer.

In general, according to one embodiment, an image forming apparatus includes an image carrier, a sensor, a light amount control unit, and an image formation control unit. The sensor detects the amount of developer in a visible image which is formed in the image carrier by emitting light to the image carrier and receiving light that is reflected from the image carrier. The light amount control unit determines the amount of light which is emitted by the sensor when the amount of developer is detected. The image formation control unit controls the amount of developer of a visible image which is formed in the image carrier in accordance with the amount of developer that is detected by the sensor. The light amount control unit determines the amount of light in accordance with a statistical value of the amount of received light of the reflected light in a region in which the visible image is not formed.

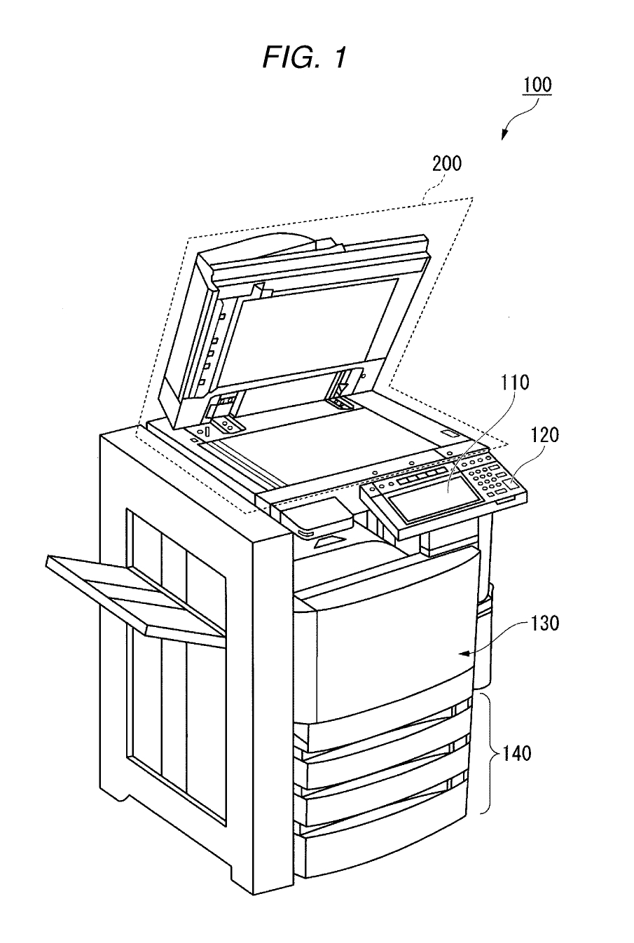

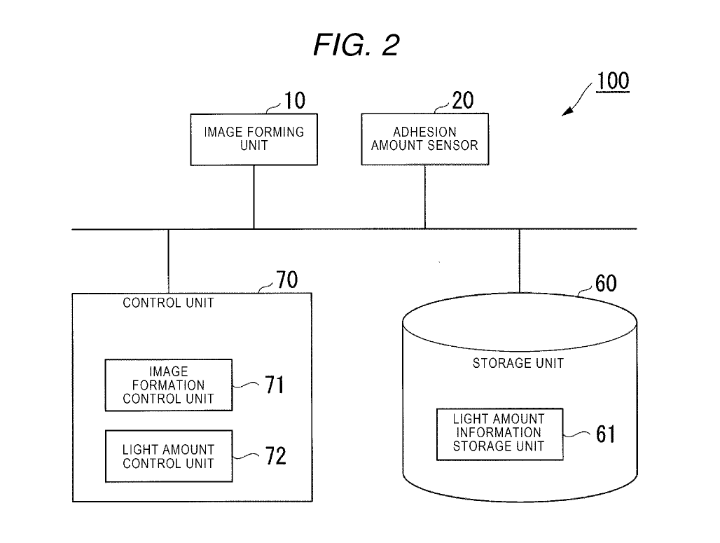

FIG. 1 is an external view illustrating an overall configuration example of an image forming apparatus 100 according to an embodiment. The image forming apparatus 100 is, for example, a multi-function peripheral. The image forming apparatus 100 includes a display 110, a control panel 120, a printer unit 130, a sheet containing unit 140, and an image reading unit 200. In addition, the image forming apparatus includes a control unit 70 which controls an overall device as illustrated in FIG. 2. The image forming apparatus 100 forms an image on a sheet by using developer such as toner. The sheet is, for example, paper or label paper. The sheet may be any type of material if the image forming apparatus 100 can form an image on the material.

The display 110 is an image display device such as a liquid crystal display or an organic electro luminescence (EL) display. The display 110 displays various types of information on the image forming apparatus 100.

The control panel 120 has a plurality of buttons. The control panel 120 receives input data of a user. The control panel 120 outputs a signal according to an operation which is performed by the user to a control unit of the image forming apparatus 100. The display 110 and the control panel 120 may be configured with a touch panel of one piece.

The printer unit 130 prints an image on the sheet, based on image information which is generated by the image reading unit 200 or image information which is received through a communication path. The printer unit 130 includes an image forming unit 10, a fixing unit 30, a paper discharging unit 40, a transport unit, and the like which will be described below. The printer unit 130 prints an image by using, for example, developer such as toner. The sheet on which an image is formed may be contained in the sheet containing unit 140, or may be inserted by hand.

The sheet containing unit 140 contains sheets which are used for image formation of the printer unit 130.

The image reading unit 200 reads image information of a read target by using brightness and darkness of light. The image reading unit 200 records the read image information. The recorded image information may be transmitted to other information processing devices through a network. An image of the recorded image information may be formed on the sheet by the printer unit 130.

FIG. 2 is a block diagram illustrating a functional configuration relating to visible image formation processing of the image forming apparatus 100 according to the embodiment. The visible image formation processing is processing in which a visible image is formed by transferring the visible image on the sheet. The image forming apparatus 100 includes the image forming unit 10, an adhesion amount sensor 20, a storage unit 60, and the control unit 70.

The image forming unit 10 operates in accordance with control of an image formation control unit 71. The image forming unit 10 includes an exposure unit, a development unit, a first transfer unit, a second transfer unit, and the like which will be described below. For example, the image forming unit 10 operates as follows. The exposure unit of the image forming unit 10 forms an electrostatic latent image on a photoconductive drum on the basis of image information which becomes a target of image formation. The development unit of the image forming unit 10 forms a visible image by adhering developer to the electrostatic latent image. The first transfer unit of the image forming unit 10 transfers the formed visible image to an image carrier. The second transfer unit of the image forming unit 10 transfers the visible image formed in the image carrier onto a sheet.

The adhesion amount sensor 20 detects the amount of adhesion of the developer of the visible image formed in the image carrier of the image forming unit 10. The adhesion amount sensor 20 may be configured with, for example, an optical sensor.

The storage unit 60 is configured with a storage device such as a magnetic hard disk device or a semiconductor device. The storage unit 60 functions as a light amount information storage unit 61. The light amount information storage unit stores light amount information. The light amount information is information which is obtained by associating an output of the adhesion amount sensor 20 in a light amount adjustment mode with a light emission voltage when the output is obtained.

The control unit 70 functions as an image formation control unit 71 and a light amount control unit 72, as a CPU executes a program. The image formation control unit 71 performs density adjustment processing. In the density adjustment processing, the image formation control unit 71 acquires detection results of the adhesion amount sensor 20 by using a toner adhesion amount pattern formed in the image carrier as a target. The image formation control unit 71 controls development conditions (for example, development potential) of the development unit in accordance with the detection results such that density of the visible image which is formed in the image carrier has an appropriate value. In a case where the detection results of the adhesion amount sensor 20 indicate that “the density is high”, the image formation control unit 71 controls the development conditions such that the amount of adhesion of the developer in the image carrier is decreased. In a case where the detection results of the adhesion amount sensor 20 indicate that “the density is low”, the image formation control unit controls the development conditions (for example, development potential) such that the amount of adhesion of the developer in the image carrier is increased.

The light amount control unit 72 controls the amount of light of the light emission unit of the adhesion amount sensor 20 in accordance with the detection results of the adhesion amount sensor 20 in the light amount adjustment mode.

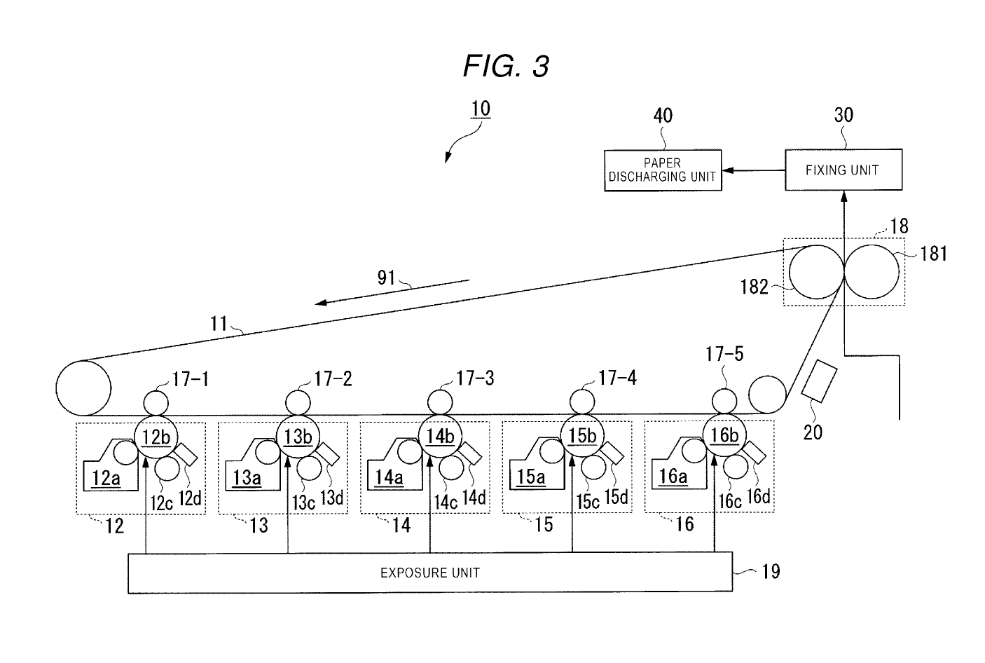

FIG. 3 is a diagram illustrating an example of an internal configuration of the image forming apparatus 100. In the example of FIG. 3 the image forming apparatus 100 is an image forming apparatus of a quintuple tandem type. However, the image forming apparatus 100 does not need to be limited to the quintuple tandem type.

The image forming apparatus 100 includes the image forming unit 10, the adhesion amount sensor 20, the fixing unit 30, and the paper discharging unit 40. The image forming unit 10 includes an intermediate transfer body 11, development units 12 to 16, a plurality of first transfer rollers 17 (17-1 to 17-5), a second transfer unit 18, and an exposure unit 19.

The intermediate transfer body 11 is a specific example of the image carrier. The intermediate transfer body 11 may be configured with, for example, an endless belt. The intermediate transfer body 11 rotates in a direction of an arrow 91 by rollers. In the embodiment, upstream and downstream are defined based on a direction in which the intermediate transfer body 11 moves. Visible images generated by the development units 12 to 16 are transferred onto a surface of the intermediate transfer body 11. Transferring the visible image to the intermediate transfer body 11 corresponds to a first transfer process.

The development units 12 to 16 form the visible images by using toners with respectively different properties. For example, a part of the development units may use the toners of respectively different colors. The toners of each color of yellow (Y), magenta (M), cyan (C), and black (K) may be used as the toners of different colors. For example, a part of the development units may use toner whose color disappears due to external stimulus (for example, heat). The development unit 12 is located at the most upstream among the five development units, and the development unit 16 is located at the most downstream among the five development units.

The development units 12 to 16 use toners with different properties, but have the same configurations. Hereinafter, the development units will be described by using the development unit 12 as an example.

The development unit 12 includes a development machine 12a, a photoconductive drum 12b, a charger 12c, and a cleaning blade 12d.

The development machine 12a contains developer. The development machine 12a makes the developer adhere to the photoconductive drum 12b.

The photoconductive drum 12b includes a photoreceptor (photosensitive region) on an outer circumference surface thereof. The photoreceptor is, for example, an organic photoconductor (OPC).

The charger 12c uniformly charges a surface of the photoconductive drum 12b.

The cleaning blade 12d is, for example, a member of a plate shape. The cleaning blade 12d is configured with rubber such as urethane resin. The cleaning blade 12d removes the developer which adheres to the photoconductive drum 12b.

Next, a schematic operation of the development unit 12 will be described. The photoconductive drum 12b is charged with a predetermined potential by the charger 12c. Subsequently, the exposure unit 19 irradiates the photoconductive drum 12b with light. Thereby, a potential of a region of the photoconductive drum 12b to which light is applied changes. An electrostatic latent image is formed on a surface of the photoconductive drum 12b by the change. The electrostatic latent image on the surface of the photoconductive drum 12b is developed by the developer of the development machine 12a. That is, a visible image which is an image developed by the developer is formed on the surface of the photoconductive drum 12b.

The first transfer rollers 17 (17-1 to 17-5) transfer the visible images which are formed on the photoconductive drum by the respective development units 12 to 16 to the intermediate transfer body 11.

The second transfer unit 18 includes a second transfer roller 181 and a second transfer counter roller 182. The second transfer unit 18 collectively transfers the visible images formed on the intermediate transfer body 11 to a sheet which becomes a target of image formation. The transfer which is performed by the second transfer unit 18 is realized by a potential difference between, for example, the second transfer roller 181 and the second transfer counter roller 182.

The exposure unit 19 forms the electrostatic latent image by irradiating the photoconductive drums of the development units 12 to 16 with light. The exposure unit 19 includes a light source such as laser or a light emitting diode (LED).

The adhesion amount sensor 20 is located between the development unit 16 in the most downstream and the second transfer unit 18, and is provided to detect the amount of adhesion of the developer on the intermediate transfer body 11.

The fixing unit 30 fixes the visible image on the sheet by heating and pressing the visible image transferred onto the sheet.

The paper discharging unit 40 discharges the sheet on which the visible image is fixed by the fixing unit 30.

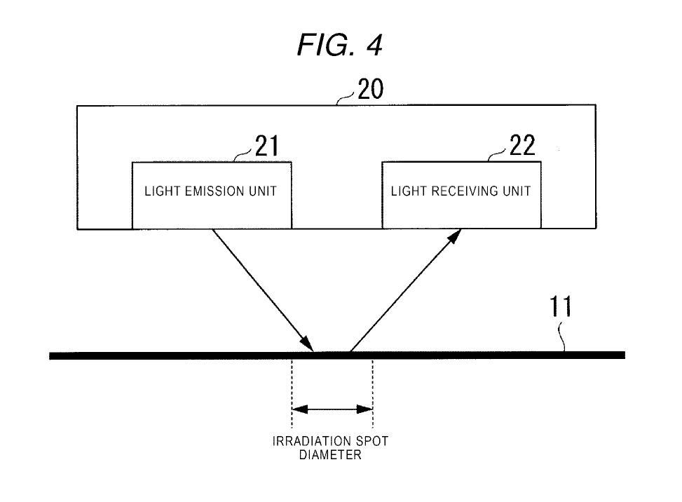

FIG. 4 is a diagram illustrating a specific example of a configuration of the adhesion amount sensor 20. The adhesion amount sensor 20 includes a light emission unit 21 and a light receiving unit 22. The light emission unit 21 emits light to the intermediate transfer body 11. The light emission unit 21 is configured with a light emitting element such as a light emitting diode (LED). The light which is emitted by the light emission unit 21 is reflected from a region (hereinafter, referred to as an “irradiation spot”) of a predetermined size in the intermediate transfer body 11. A width of the irradiation spot is referred to as an “irradiation spot diameter”. The light receiving unit 22 receives the light reflected from the intermediate transfer body 11. The light receiving unit 22 outputs a voltage value according to the amount of received light. The light receiving unit 22 is configured with, for example, a photoelectric element.

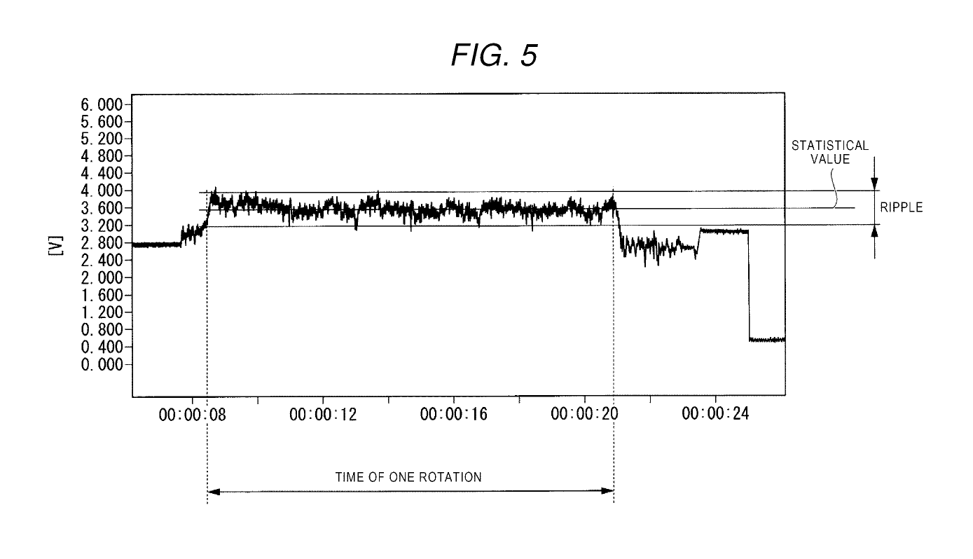

FIG. 5 is a diagram illustrating a specific example of an output of the adhesion amount sensor 20 in the light amount adjustment mode. In FIG. 5, a vertical axis denotes a voltage value which is output by the light receiving unit 22 of the adhesion amount sensor 20. A horizontal axis denotes time. In the light amount adjustment mode, the light amount control unit 72 continuously acquires an output of the adhesion amount sensor 20 in a region in which the visible image is not formed while the intermediate transfer body 11 makes at least one rotation. In the light amount adjustment mode, the voltage value is acquired by using a portion in which an image is not formed as the irradiation spot, in the surface of the intermediate transfer body 11. As illustrated in FIG. 5, a ripple with a certain degree of width occurs in the voltage value. The light amount control unit 72 calculates a statistical value (hereinafter, referred to as a “voltage statistical value”) of the acquired voltage value. The voltage statistical value is, for example, an average value, a most frequent value, or an intermediate value. It is preferable that the voltage statistical value is less than a maximum value and is larger than a minimum value. The light amount control unit 72 determines a light emission voltage on the basis of the acquired voltage statistical value, such that a voltage value becomes a value within a predetermined range in a case where a portion in which an image is not formed becomes the irradiation spot. The light emission unit 21 of the adhesion amount sensor 20 emits light with the determined light emission voltage when density adjustment processing is performed.

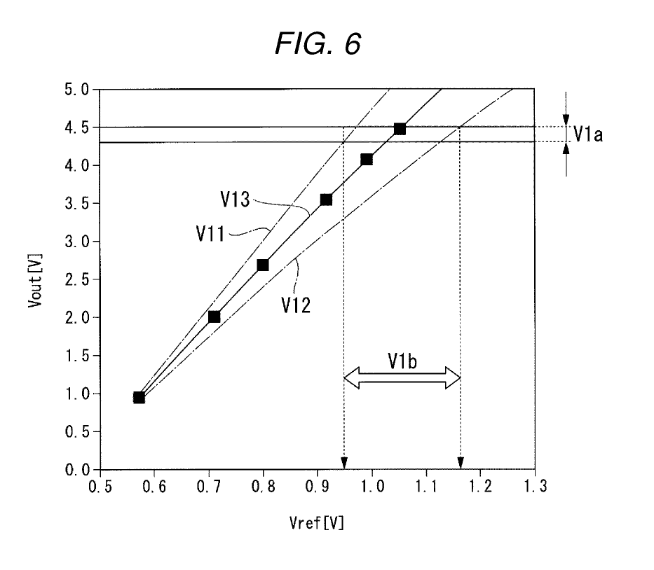

Hereinafter, effects of the image forming apparatus 100 according to the embodiment will be described with reference to FIGS. 6 to 9. FIG. 6 is a diagram illustrating voltage values (hereinafter, referred to as “reference voltage values”) which are obtained when a portion in which an image is not formed is set as the irradiation spot, in a case where the density adjustment processing is performed by control of the related art. A vertical axis denotes the voltage value which is output by the adhesion amount sensor 20. A horizontal axis denotes light emission voltage values. V11 indicates a maximum value in variation of the reference voltage value due to the ripple. V12 indicates a minimum value in the variation of the reference voltage value due to the ripple. V13 indicates a statistical value (an average value in the embodiment) of the reference voltage value. In a case where the light emission voltage value is controlled such that a value of the reference voltage value is located within a range of V1a, the light emission voltage value is controlled in a range of V1b due to influence of the ripple.

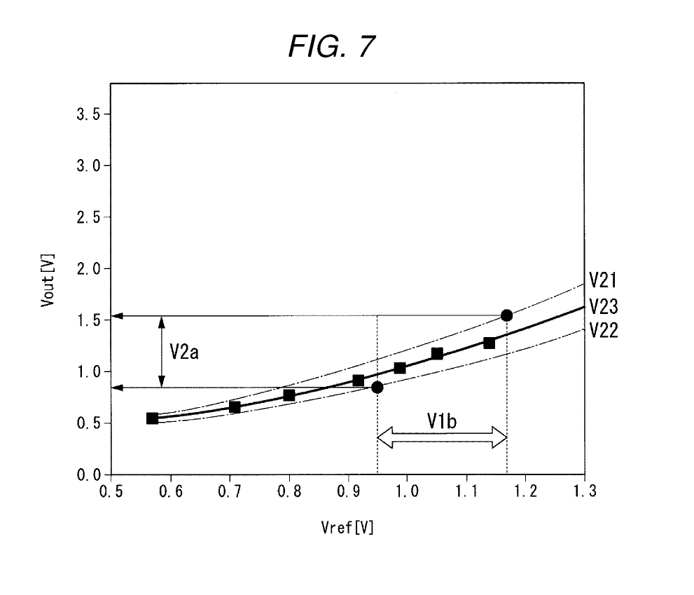

FIG. 7 is a diagram illustrating voltage values (hereinafter, referred to as “image voltage values”) which are obtained when a portion in which a visible image is formed is set as the irradiation spot, in a case where the density adjustment processing is performed by the control of the related art. V21 indicates a maximum value in variation of the image voltage value due to the ripple. V22 indicates a minimum value in the variation of the image voltage value due to the ripple. V23 indicates a statistical value of the image voltage value. In a case where the light emission voltage value is controlled by a value of V1b determined in FIG. 6, a value of the image voltage value takes a value within a range of V2a. That is, even in a case where developers of the same amount adhere, the obtained voltage value can change with a width of V2a. As such, since a magnitude of V2a is significantly large, detection accuracy of the amount of developer decreases.

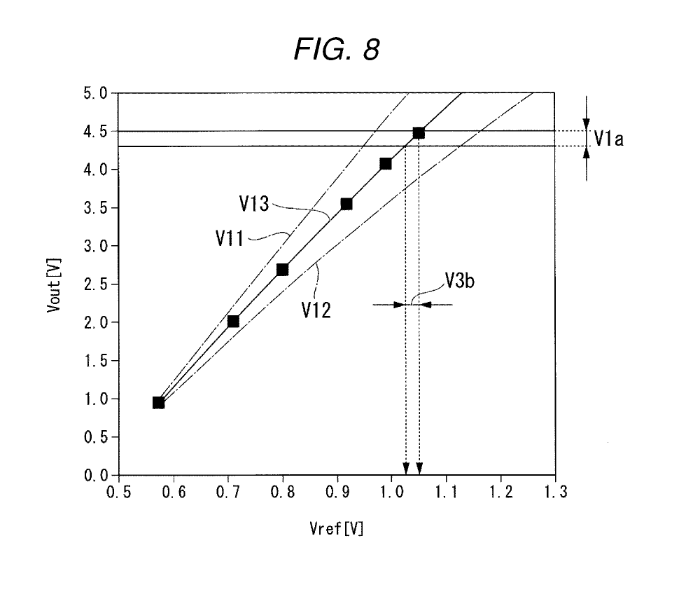

FIG. 8 is a diagram illustrating the reference voltage values, in a case where the density adjustment processing is performed by control of the image forming apparatus 100 according to the embodiment. A vertical axis denotes a voltage value which is output by the adhesion amount sensor 20. A horizontal axis denotes the light emission voltage value. In a case where the light emission voltage value is controlled such that a statistical value of the reference voltage value is located within a range of V1a, the light emission voltage value is controlled in a range of V3b although there is an influence of the ripple. As such, V3b becomes a small value in comparison to V1b in FIG. 6.

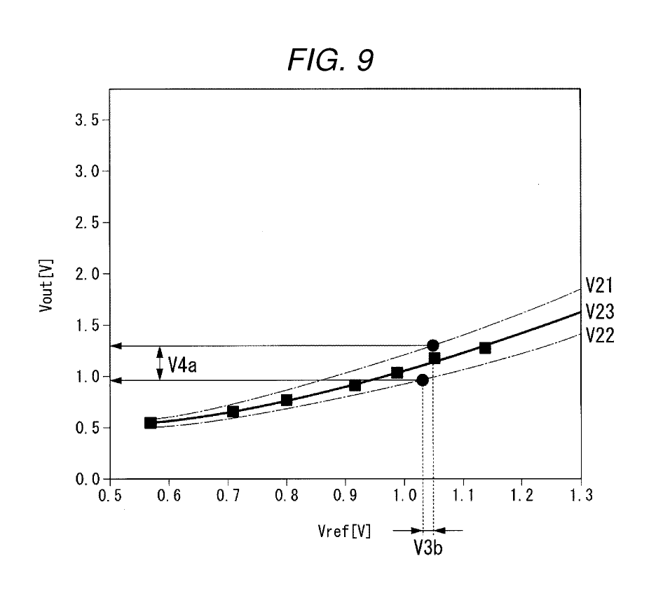

FIG. 9 is a diagram illustrating the image voltage values, in a case where the density adjustment processing is performed by control of the image forming apparatus 100 according to the embodiment. In a case where the light emission voltage value is controlled by a value of V3b determined in FIG. 8, the image voltage value takes a value within a range of V4a. That is, the voltage value which is obtained in a case where developers of the same amount adhere can change with a width of V4a. As such, V4a takes a small value in comparison to V2a in FIG. 7. Accordingly, it is possible to increase the detection accuracy of the amount of developer, compared with the related art.

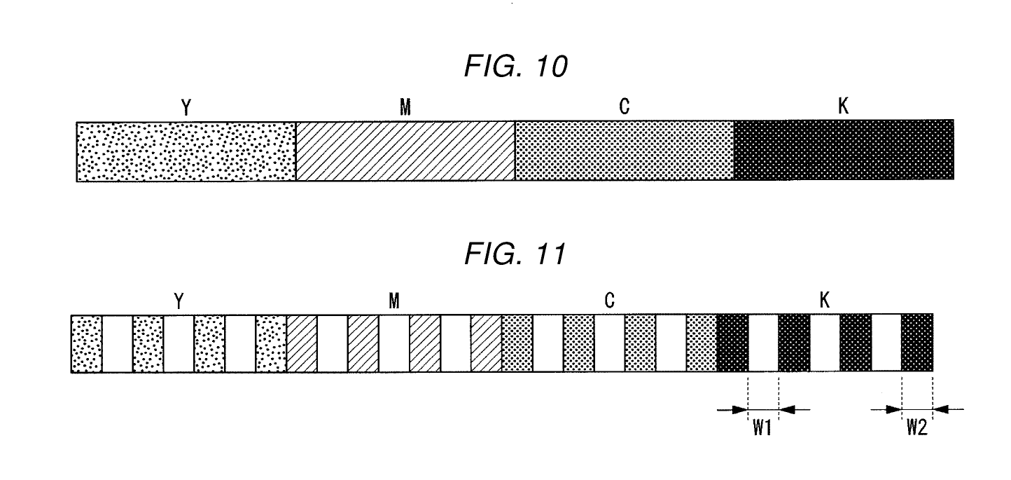

Next, the density adjustment processing of the image forming apparatus 100 will be described. FIG. 10 is a diagram illustrating a specific example of a toner adhesion amount pattern which is used for the density adjustment processing of the related art. FIG. 11 is a diagram illustrating a specific example of the toner adhesion amount pattern which is used for the density adjustment processing of the image forming apparatus 100 according to the embodiment. A shape of the toner adhesion amount pattern may be controlled by the image formation control unit 71. In the image forming apparatus 100 according to the embodiment, a white portion (hereinafter, referred to as a “white portion”) to which toner does not adhere is provided in the toner adhesion amount pattern. In a case of FIG. 11, a width of the white portion is W1, and a width of a portion (hereinafter, referred to as a “toner portion”) to which the toner adheres is W2. W1 and W2 are configured to be at least values larger than the irradiation spot diameter.

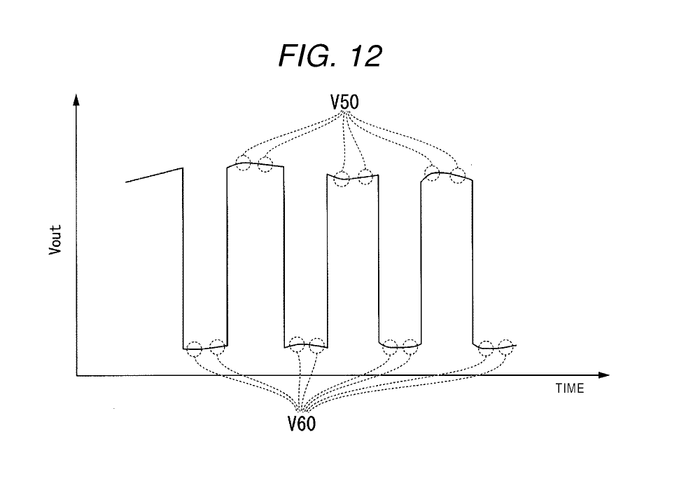

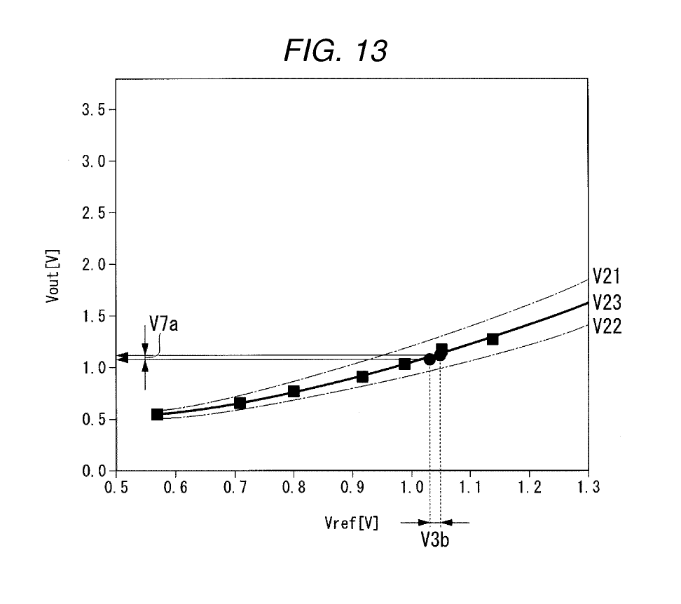

FIG. 12 is a diagram illustrating a specific example of voltage values which are obtained in a case where the density adjustment processing is performed by using the toner adhesion amount pattern having the white portion. The image formation control unit 71 corrects a voltage value V60 which is obtained in the toner portion by using a voltage value V50 which is obtained in the white portion, the voltage value V60 which is obtained in the toner portion, and the voltage statistical value. A statistical value of a plurality of voltage values V50 may be used as the voltage value V50. A statistical value of a plurality of voltage values V60 may be used as the voltage value V60. The corrected voltage value may be obtained, for example, as follows.

Corrected voltage value=V60−α×(V50−statistical voltage value)

α is a constant value and is appropriately determined. For example, α is a value less than “1”. A value of α may be, for example, 0.2. The image formation control unit 71 performs the density adjustment processing by using the corrected voltage value. That is, the image formation control unit 71 detects the amount of the developer on the basis of the corrected voltage value.

Hereinafter, effects of the density adjustment processing of the image forming apparatus 100 according to the embodiment will be described with reference to FIG. 13. In FIG. 13, in a case where the light emission voltage value is controlled by a value of V3b determined in FIG. 8, a value of the image voltage value takes a value within a range of V7a. That is, the voltage value which is obtained in a case where the developer of the same amount adheres changes with a width of V7a. As such, V7a takes a smaller value than V2a in FIG. 7 or V4a in FIG. 9. Accordingly, it is possible to further increase the detection accuracy of the amount of developer compared with the related art.

An operation of the light amount adjustment mode may be performed at timing when an image is not formed. For example, the operation of the light amount adjustment mode may be performed in parallel with processing in which the image carrier does not form the visible image, in processing that the image forming apparatus 100 requires. For example, the operation of the light amount adjustment mode may be performed in parallel with a calibration operation of a magnetic developer concentration sensor of the development machine. For example, the operation of the light amount adjustment mode may be performed in parallel with toner supplying to the development machine after the toner is emptied. By configuring so, the operation of the light amount adjustment mode can be efficiently performed.

The operation of the light amount adjustment mode may be performed each time the predetermined number of images is formed. The operation of the light amount adjustment mode may be performed at a predetermined time interval. The operation of the light amount adjustment mode may be performed at a predetermined time.

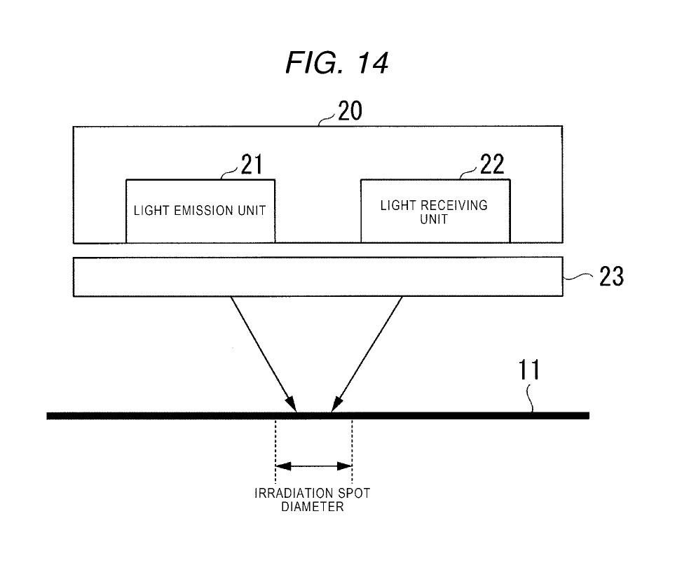

FIG. 14 is a diagram illustrating a modified example of the adhesion amount sensor 20. The adhesion amount sensor 20 may include an openable and closable shutter 23. The shutter 23 is provided between the light emission unit 21 and the light receiving unit 22, and the intermediate transfer body 11. The shutter 23 is opened in a case where the adhesion amount sensor 20 operates. The shutter 23 is closed in a case where the adhesion amount sensor 20 does not operate. Opening and closing of the shutter 23 may be controlled by, for example, the control unit 70. By configuring so, it is possible to prevent the developer from adhering to a surface of the light emission unit 21 or a surface of the light receiving unit 22. Accordingly, it is possible to increase accuracy of the operation of the light amount adjustment mode or the density adjustment processing.

A statistical value of the voltage values of one rotation of the image carrier is acquired in the aforementioned light amount adjustment mode, but it does not always need to be one rotation. For example, a statistical value of the voltage values of half a rotation of the image carrier may be acquired, or a statistical value of the voltage values of one and a half rotation may be acquired.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming apparatus comprising:
an image carrier;
a sensor that detects the amount of developer in a visible image which is formed in the image carrier by emitting light to the image carrier and receiving light that is reflected from the image carrier, wherein the sensor comprises a light emission unit and a light receiving unit that outputs a voltage value based on an amount of received light;
a light amount control unit that determines an amount of light which is emitted by the sensor when the amount of developer is detected, based on calculating a voltage statistical value of a first voltage value that is output by the light receiving unit of received light of reflected light in a plurality of regions in which the visible image is not formed; and
an image formation control unit that controls the amount of developer of a visible image which is formed in the image carrier in accordance with the amount of developer that is detected by the sensor, wherein the image formation control unit corrects a voltage value which is obtained in a toner portion by using a second voltage value which is obtained in the white portion, the second voltage value which is obtained in the toner portion, and the voltage statistical value, wherein the corrected voltage value is equal to the second voltage value minus a constant value that is multiplied by a difference between the first voltage value and the statistical voltage value, and wherein the image formation control unit performs a density adjustment processing based on the corrected voltage value,
wherein the light amount control unit determines the amount of light in accordance with the voltage statistical value.

2. The apparatus according to claim 1,
wherein the image carrier is an endless belt, and
wherein the light amount control unit continuously acquires the amount of received light of the reflected light in a region in which the visible image is not formed while the image carrier makes at least one rotation, and determines the amount of light in accordance with the statistical value of the acquired amount of received light.

3. The apparatus according to claim 1, wherein the statistical value is less than a maximum value of the amount of received light and is larger than a minimum value of the amount of received light.

4. The apparatus according to claim 1, wherein the light amount control unit acquires the amount of received light at timing when processing of forming the visible image in the image carrier is not performed.

5. The apparatus according to claim 1, wherein the image formation control unit forms an image, that comprises the visible image and a white portion which is a portion in which the developer is not used, in the image carrier when the amount of developer is detected and detects the amount of developer in the visible image by using a second amount of received light of light which is reflected from the visible image and the first amount of received light of light which is reflected from the white portion.
